(19) United States
(12) Patent Application Publication
(10) Pub. No.: US 2012/0081773 A1
(43) Pub. Date: Apr. 5, 2012

(54) ELECTROCHROMIC UNIT AND STEREO IMAGE DISPLAY DEVICE HAVING THE SAME

(75) Inventors: YU-CHOU YEH, TAOYUAN COUNTY (TW); CHAO-YI WANG, TAOYUAN COUNTY (TW); WEN-CHIH LO, TAOYUAN COUNTY (TW); CHI-HSIEN SUNG, TAOYUAN COUNTY (TW); TSUNG-HER YEH, TAIPEI COUNTY (TW)

(73) Assignee: J TOUCH CORPORATION, TAOYUAN COUNTY (TW)

(21) Appl. No.: 12/968,504

(22) Filed: Dec. 15, 2010

(30) Foreign Application Priority Data
Oct. 5, 2010 (TW) 099133877

(51) Int. Cl. G02F 1/153

(52) U.S. Cl. 359/265; 977/742; 977/932

(57) ABSTRACT

In an electrochromic module and a stereo image display device having the electrochromic module, the electrochromic module includes a first substrate, a second substrate, at least one electrochromic layer and at least one ion layer. The first substrate upper surface includes at least one first electrically conductive element disposed between the first substrate and the second substrate. The ion layer is formed on a surface of the electrochromic layer and prepared by mixing and dissolving at least one organic material and at least one inorganic material in a solvent. The ion layer not only serves as an ion provider, but also acts as an electrochromic material of an accessory color change layer for improving the difference of the optical transmittance. By the shifting and transmission of electrons between the organic and inorganic materials, the electrochromic module has the advantages of fast and uniform color change and smaller driving voltage.

### CROSS-REFERENCE TO RELATED APPLICATIONS

This non-provisional application claims priority under 35 U.S.C. §119(a) on Patent Application No(s). 099133877 filed in Taiwan, R.O.C. on Oct. 5, 2010, the entire contents of which are hereby incorporated by reference.

### BACKGROUND OF THE INVENTION

1. Field of the Invention

The present invention relates to an electrochromic unit and a stereo image display device having the electrochromic unit, and more particularly to an electrochromic unit and a display device having the electrochromic unit, and an electrochromic material is used as an ion layer for providing ions to an electrochromic layer, and the ion layer is prepared by mixing at least one organic material with at least one inorganic material in a solvent.

2. Description of the Related Art

Electrochromism (EC) refers to a reversible color change caused by a light absorption or a light diffusion occurred in an electrochromic material under the effect of a current or an electric field.

With reference to FIG. 1 for a schematic view of a conventional electrochromic module, the electrochromic module 1 comprises a first substrate 11, a second substrate 12, an electrochromic layer 13 and an electrolyte layer 14. The first substrate 11 includes a first electrically conductive element 111 disposed on an upper surface of the first substrate 11, and the second substrate 12 includes a second electrically conductive element 121 disposed on a lower surface of the second substrate 12. The first electrically conductive element 111 and/or the second electrically conductive element 121 provide electrons and the electrolyte layer 14 provides ions to the electrochromic layer 13, such that the ions can enter into a crystal lattice to produce a coloration effect. With reference to FIG. 2 for a schematic view of another conventional electrochromic module, this electrochromic module is constructed according to the structure of the electrochromic module as depicted in FIG. 1, and the electrolyte layer 14 further includes an electrochromic layer 15 disposed in another opposite direction to serve as an ion storage layer and an accessory electrochromic layer, and whose coloration polarity and opposite effect of the electrochromic layer 13 can improve the difference of the optical transmittance.

The conventional electrochromic module is made of an oxides or a hydroxide of a transition element or their derivatives produced in form of an inorganic solid thin film or a composite material produced by mixing an organic compound/electrolyte material. With the electrons and an additional ion source (such as the electrolyte or the second electrochromic material), ions of WO₃, Ni(OH)₂, or Prussian blue entering into the crystal lattice will produce a coloration effect.

The conventional electrolyte layer is mainly divided into a solid-state electrolyte, a liquid-state electrolyte and a gel-state electrolyte, but the material used as the aforementioned electrolyte just provides the function of supplying ions to the electrochromic layer. If it is necessary to improve the difference of the optical transmittance, then an electrochromic layer 15 as shown in FIG. 2 should be formed. As a result, the thickness of the electrochromic module 1 will be increased, and the increased thickness is unfavorable for the application of the electrochromic module 1.

The principle of present well-known stereo image display technologies adopts a binocular disparity for receiving different images from both left and right eyes of a user respectively, and finally the user's brain merges the images into a stereo image. In naked-eye stereo display technologies, there are two main types of structures, respectively: lenticular lens and barrier. An electrochromic material is used to achieve the barrier, and some patents related to 3D image display devices with a function of switching to the display of 3D images or 2D images are listed below:

As disclosed in R.O.C. Pat. No. M368088 entitled “Integrated electrochromic 2D/3D display device, R.O.C. Pat. No. M371902 entitled “Display device for switching 2D image/3D image display screen”, R.O.C. Pat. No. I296723 entitled “Color filter used for 3D image LCD panel manufacturing method thereof”, and U.S. Pat. Application No. 2006087499 entitled “Autostereoscopic 3D display device and fabrication method thereof”, electrochromic materials are used as a parallax barrier device for displaying 3D images.

Both Pat. Nos. M368088 and M371902 have a common drawback of lacking a necessary electrolyte layer required by electrochromic devices, since ions are not supplied to the electrolyte layer of the electrochromic layer, and the electrochromic device cannot produce a reversible oxidation or reduction to complete the change of coloration or decoloration, so that the aforementioned patents are not feasible in practical applications. In addition, the transparent electrode layer and electrochromic material layer of the parallax barrier device are grid patterned, and whose manufacturing process requires a precise alignment for coating, spluttering or etching each laminated layer, and thus the manufacturing process is very complicated, and all laminated layers are grid patterned, so that a hollow area is formed between one grid and the other, and the overall penetration, refraction and reflection of the light will be affected adversely. Even for the general 2D display, the video display quality of the display device will be affected to cause problems related to color difference and uneven brightness. In addition, the structural strength of the display device is low, and the using life is short. The Pat. No. 1296723 disclosed an embedded liquid display device (LCD) formed in a structure of a color filter plate, and conventional electrochromic materials and chromic mechanisms are adopted for the electrochromic layer of the aforementioned patents and thus requiring a greater driving voltage, causing a defect of the material easily, and resulting in a shorter using life.

Therefore, it is an important subject for the present invention to develop an electrochromic module capable of improving the difference of the optical transmittance without increasing the thickness of the electrochromic module and apply the electrochromic modules to a stereo image display device.

### SUMMARY OF THE INVENTION

In view of the aforementioned shortcomings, the inventor of the present invention based on years of experience in the related industry to conduct extensive researches and experiments, and finally developed an electrochromic module in accordance with the present invention, in hope of achieving the effects of simplifying the manufacturing procedure and improving the difference of optical transmittances without increasing the thickness.

Another objective of the present invention is to provide an electrochromic module having an ion layer prepared by dissolving at least one organic material and at least one inorganic material in a solvent and used as an electrolyte layer and an accessory electrochromic layer.

Another objective of the present invention is to provide an electrochromic module with a quick coloration/decoloration, a long life cycle, and a small driving voltage.

Another objective of the present invention is to provide an electrochromic module with a darker color after a color change of an electrochromic material.

To achieve the foregoing objectives, the present invention provides an electrochromic module, comprising: a first substrate, having at least one first electrically conductive element disposed on an upper surface of the first substrate; a second substrate; at least one electrochromic layer, disposed between the first substrate and the second substrate; and at least one ion layer, disposed on a surface of the electrochromic layer, and made of a material prepared by mixing and dissolving at least one organic material and at least one inorganic material dissolved into a solvent.

The electrochromic module of the present invention can be implemented by the following methods:

1. If the electrochromic module comes with a plurality of first electrically conductive elements, electrochromic layers and ion layers, each of the first electrically conductive elements is in form of a containing slot for containing the corresponding electrochromic layer and ion layer.

2. If the electrochromic module comes with a plurality of first electrically conductive elements, and electrochromic layers, a plurality of isolating units is further installed among the first electrically conductive elements, the electrochromic layers and the ion layers.

3. If the electrochromic module comes with a plurality of first electrically conductive elements and electrochromic layers, the first electrically conductive elements provide positive and negative voltages alternately, and each of the electrochromic layers is in form of a containing slot for containing the corresponding first electrically conductive element that carries negative electricity.

4. If the electrochromic module comes with a plurality of first electrically conductive elements and electrochromic layers, the first electrically conductive elements provide positive and negative voltages, and the electrochromic layers are disposed on the first electrically conductive elements that carry negative electricity respectively.

Since the first electrically conductive elements provide different positive and negative voltages, the electrochromic layer and the ion layer can be colored or decolored.

The electrochromic module of the present invention further comprises at least one second electrically conductive element disposed on a lower surface of the second substrate. Similarly, the second electrically conductive elements are in any of the aforementioned four structures:

1. If the electrochromic module comes with a plurality of first electrically conductive elements and second electrochromic layers, each of the first and second electrically conductive elements is in form of a containing slot for containing the corresponding electrochromic layer and ion layer.

2. If the electrochromic module comes with a plurality of first electrically conductive elements, second electrically conductive elements, electrochromic layers and ion layers, a plurality of isolating units is installed among the first electrically conductive elements, the second electrically conductive elements, the electrochromic layers and the ion layers.

3. If the electrochromic module comes with a plurality of first electrically conductive elements and electrochromic layers, the first electrically conductive elements provide positive and negative voltages alternately, and the second electrically conductive elements provide a positive voltage, and each of the electrochromic layers is in form of a containing slot for containing the corresponding first electrically conductive element that carries negative electricity.

4. If the electrochromic module comes with a plurality of first electrically conductive elements and electrochromic layers, the first electrically conductive elements provide positive and negative voltages alternately, and the second electrically conductive elements provide a positive voltage, and the electrochromic layers are disposed respectively on the first electrically conductive elements that carry negative electricity.

Since the first electrically conductive element and the second electrically conductive element provide different positive and negative voltages and can expedite the coloration/decoloration of the electrochromic layer and the ion layer, and limit the range of color change of the electrochromic layer and the ion layer.

Another objective of the present invention is to provide a stereo image display device using the electrochromic module and capable of switching to a mode of displaying 2D images or 3D images.

To achieve the foregoing objectives, the present invention provides a stereo image display device, comprising: an image display module for displaying a planar image and a stereo image, in addition to the aforementioned electrochromic module.

In the microscopic view of the electrochromic module, a plurality of electrochromic modules is used as a grid and installed in the display device. In the overall view, the electrochromic module having a plurality of electrochromic layers is used as a grid and installed in the display device to achieve a light shielding effect.

Therefore, the electrochromic module and the stereo image display device of the present invention can improve the difference of the optical transmittance without increasing the thickness of the electrochromic module and the stereo image display device and achieve the effects of expediting the coloration/decoloration, enhancing the life cycle and requiring a small driving voltage.

### BRIEF DESCRIPTION OF THE DRAWINGS

FIG. 1 is a schematic view of a conventional electrochromic module;

FIG. 2 is a schematic view of another conventional electrochromic module;

FIG. 3 is a schematic view of an electrochromic module in accordance with a first preferred embodiment of the present invention;

FIG. 4 is a schematic view of an electrochromic module having a plurality of first electrically conductive elements in accordance with a second preferred embodiment of the present invention;

FIG. 5 is a schematic view of an electrochromic module having a plurality of first electrically conductive elements in accordance with a third preferred embodiment of the present invention;

FIG. 6 is a first schematic view of an electrochromic module having a plurality of first electrically conductive elements and electrochromic layers in accordance with a fourth preferred embodiment of the present invention;

FIG. 7 is a second schematic view of an electrochromic module having a plurality of first electrically conductive elements and electrochromic layers in accordance with a fourth preferred embodiment of the present invention;

FIG. 8 is a third schematic view of an electrochromic module having a plurality of first electrically conductive elements and electrochromic layers in accordance with a fourth preferred embodiment of the present invention;

FIG. 9 is a fourth schematic view of an electrochromic module having a plurality of first electrically conductive elements and electrochromic layers in accordance with a fourth preferred embodiment of the present invention;

FIG. 10 is a fifth schematic view of an electrochromic module having a plurality of first electrically conductive elements and electrochromic layers in accordance with a fourth preferred embodiment of the present invention;

FIG. 11 is a schematic view of an electrochromic module having a plurality of first electrically conductive elements in form of containing slots in accordance with a fifth preferred embodiment of the present invention;

FIG. 12 is a perspective view of an electrochromic module of FIG. 11;

FIG. 13 is a schematic view of an electrochromic module having a plurality of first electrically conductive elements used for isolating the electrochromic module in accordance with a sixth preferred embodiment of the present invention;

FIG. 14 is a top view of an electrochromic module of FIG. 13;

FIG. 15 is a perspective view of an electrochromic module of FIG. 13;

FIG. 16 is a schematic view of an electrochromic module having a plurality of first electrically conductive elements, electrochromic layers and ion layers, and an isolating unit disposed among therebetween in accordance with a seventh preferred embodiment of the present invention;

FIG. 17 is a schematic view of an electrochromic module concurrently comes with a plurality of electrochromic layers and an electrode function in accordance with an eighth preferred embodiment of the present invention;

FIG. 18 is a schematic view of an electrochromic module further having a second electrically conductive element in accordance with a ninth preferred embodiment of the present invention;

FIG. 19 is a schematic view of an electrochromic module with a second substrate as depicted in FIG. 9 further having a second electrically conductive element in accordance with a tenth preferred embodiment of the present invention;

FIG. 20 is a schematic view of an electrochromic module with a second substrate as depicted in FIG. 10 further having a second electrically conductive element in accordance with an eleventh preferred embodiment of the present invention;

FIG. 21 is a schematic view of an electrochromic module comes with a plurality of first and second electrically conductive elements installed sequentially and used for isolation in accordance with a twelfth preferred embodiment of the present invention;

FIG. 22 is a top view of an electrochromic module as depicted in FIG. 21;

FIG. 23 is a perspective view of an electrochromic module as depicted in FIG. 21;

FIG. 24 is a schematic view of an electrochromic module having two electrochromic layers stacked with each other in accordance with a thirteenth preferred embodiment of the present invention;

FIG. 25 is a schematic view of an electrochromic module having three electrochromic layers stacked with each other in accordance with a fourteenth preferred embodiment of the present invention;

FIG. 26 is a schematic view of an electrochromic module of the thirteenth preferred embodiment combined with the design of the sixth preferred embodiment of the present invention;

FIG. 27 is a schematic view of an electrochromic module of the fourteenth preferred embodiment combined with the design of the sixth preferred embodiment of the present invention;

FIG. 28 is a schematic view of an electrochromic module having a plurality of electrochromic modules installed to a stereo image display device of an image display module in accordance with a fifteenth preferred embodiment of the present invention; and

FIG. 29 is a schematic view of an electrochromic module of FIG. 16 installed to a stereo image display device of an image display module in accordance with a sixth preferred embodiment of the present invention.

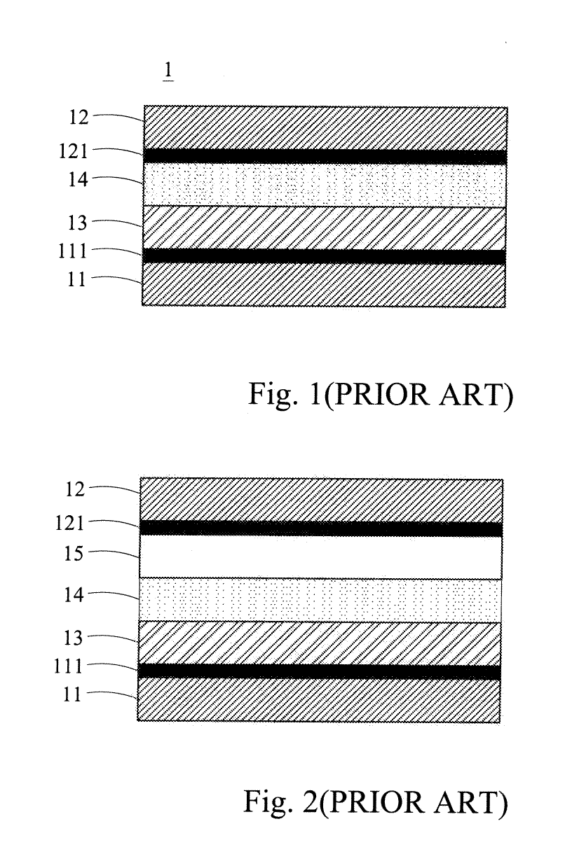

### DETAILED DESCRIPTION OF THE PREFERRED EMBODIMENTS

The technical characteristics and effects of the present invention will be apparent with the detailed description of preferred embodiment together with the illustration of related drawings as follows.

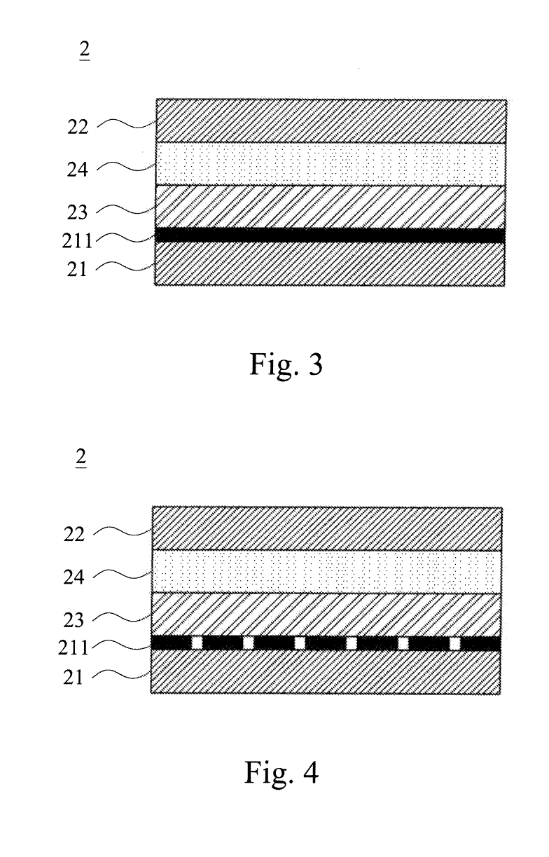

With reference FIG. 3 for a schematic view of an electrochromic module in accordance with a first preferred embodiment of the present invention, the electrochromic module 2 comprises a first substrate 21, a second substrate 22, an electrochromic layer 23 and an ion layer 24. The first substrate 21 includes a first electrically conductive element 211 disposed at an upper surface of the first substrate 21. The electrochromic layer 23 is disposed between the first substrate 21 and the second substrate 22. The ion layer 24 is disposed on a surface of the electrochromic layer 23 and grounded, and whose material is prepared by mixing and dissolving at least one or more organic material and at least one or more inorganic material into a solvent.

Therefore, when a positive voltage or negative voltage is applied to the first electrically conductive element 211 to produce a voltage difference, the first electrically conductive element 211 can remove or supply electrons to the electrochromic layer 23, and an oxidation or reduction of the electrochromic layer 23 occurs due to ions supplied by the ion layer 24 to complete a coloration/decoloration change. The ion layer 24 is made of an electrochromic material prepared by dissolving at least one organic material and at least one inorganic material into a solvent and having the redox characteristics, such that when the electrons are lost or obtained, the oxidation or reduction will occur, and the electrochromic layer 23 will have a coloration/decoloration change. In addition, parameters such as the solution concentration, potential difference, solvent polarity, pH value, electrode gap and dielectric constant of the ion layer 24 can be controlled to increase or decrease the difference of the optical transmittances of the ion layer 24.

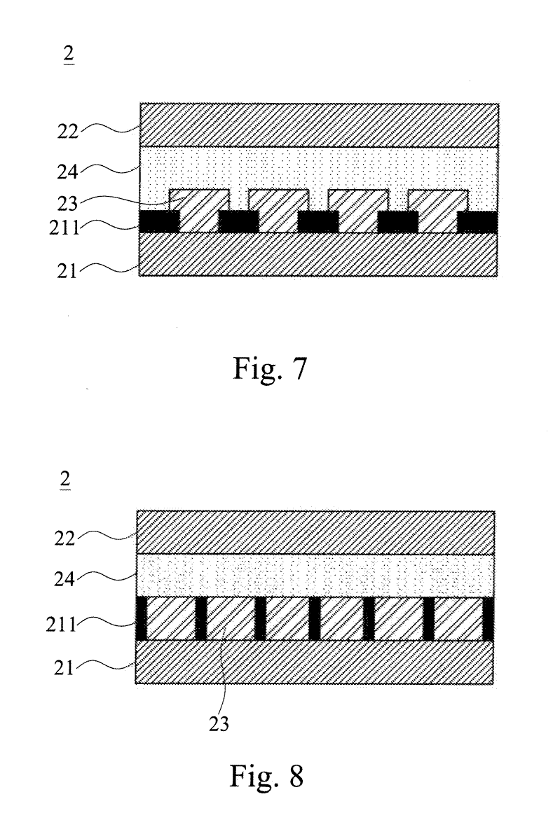

Besides, the electrochromic module 2 of the present invention can have different structural modes as shown in FIGS. 4 to 23.

With reference to FIG. 4 for a schematic view of an electrochromic module comes with a plurality of first electrically conductive elements in accordance with a second preferred embodiment of the present invention, the first electrically conductive elements 211 of the electrochromic module supply positive and negative voltages to adjust the coloration/decoloration effect and speed of each block of the electrochromic layer 23 and the ion layer 24, such that the electrochromic module 2 can be used in further applications.

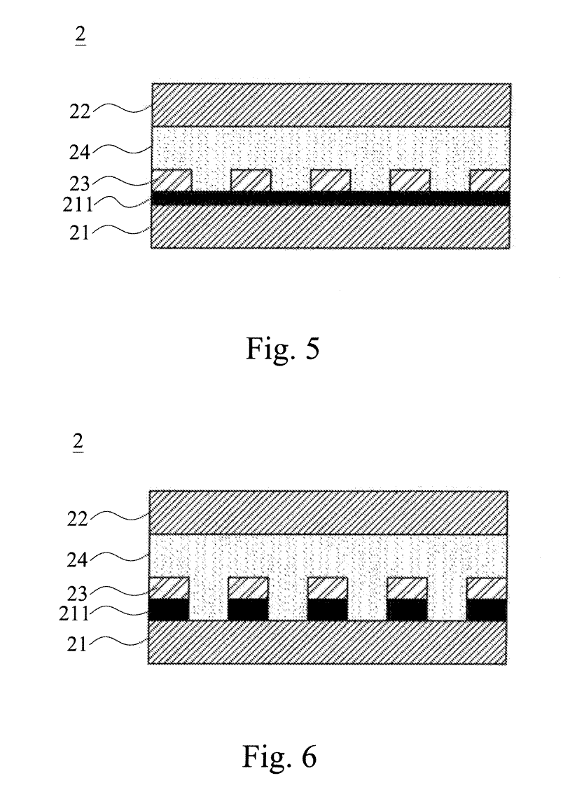

With reference to FIG. 5 for a schematic view of an electrochromic module having a plurality of first electrically conductive elements in accordance with a third preferred embodiment of the present invention, the ion layer 24 is grounded to produce a voltage difference, so that the first electrically conductive elements 211 can remove or supply electrons to the electrochromic layer 23, oxidation or reduction of the electrochromic layer 23 occurs due to ions supplied by the ion layer 24 to complete a coloration/decoloration change. The electrochromic module comes with a plurality of electrochromic layers 23 used as a grid on a stereo image display device.

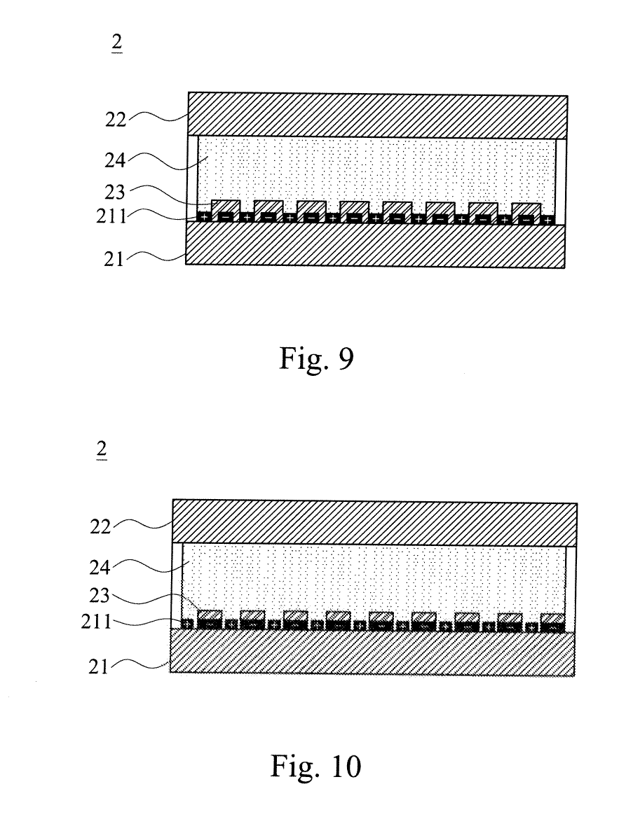

With reference to FIGS. 6 to 10 schematic views of an electrochromic module having a plurality of first electrically conductive elements and electrochromic layers in accordance with a fourth preferred embodiment of the present invention, the electrochromic module comes with a plurality of first electrically conductive elements 211 and electrochromic layers 23, and positive and negative voltages can be supplied to each first electrically conductive element 211 according to actual requirements (as shown in FIGS. 9 and 10) to adjust the coloration/decoloration effect and speed at each corresponding position of the electrochromic layer 23 and each block of the ion layer 24 so as to adjust the gap between the grids, and each of the aforementioned arrangements can be applied to produce Moiré images for the use of image coding or the adaptation for different manufacturing procedures.

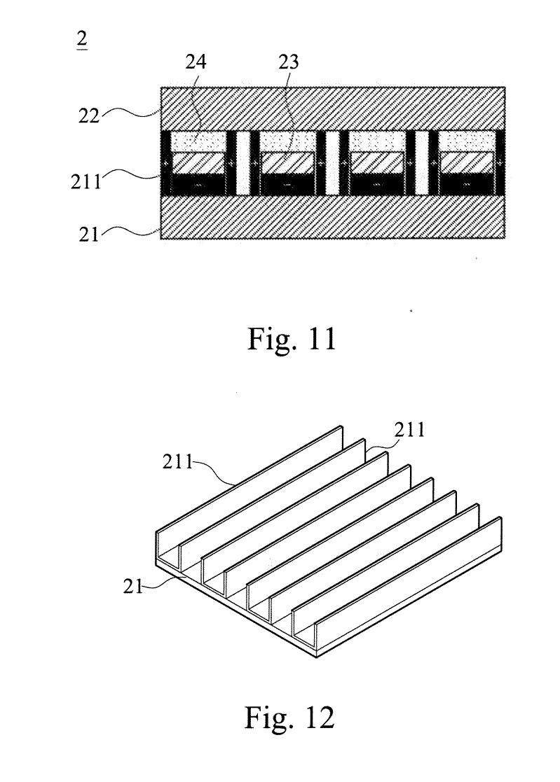

With reference to FIG. 11 for a schematic view of an electrochromic module having a plurality of first electrically conductive elements in form of containing slots in accordance with a fifth preferred embodiment of the present invention and FIG. 12 for a perspective view of the electrochromic module of FIG. 11, the electrochromic module comes with a plurality of first electrically conductive elements 211, electrochromic layers 23 and ion layers 24. Since the ion layer 24 is in form of a solution, therefore the first electrically conductive element 211 can be in form of a containing slot for storing the ion layer 24 and prevent it from being spilled over.

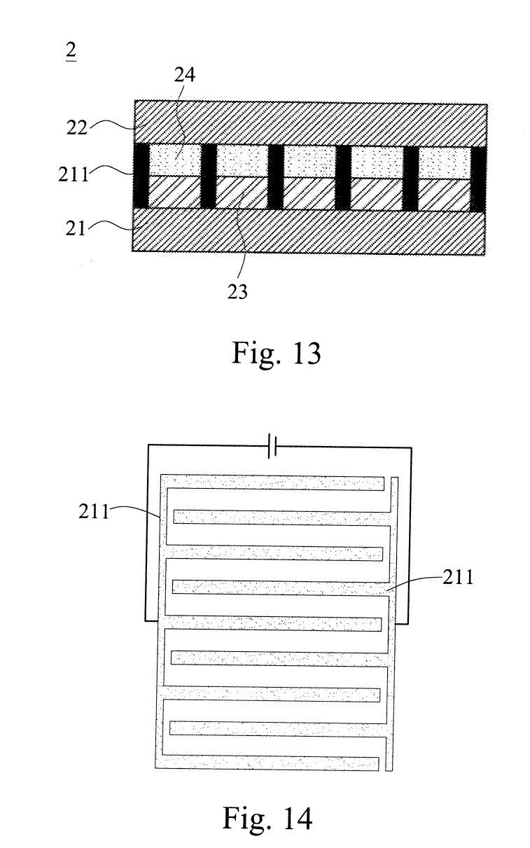

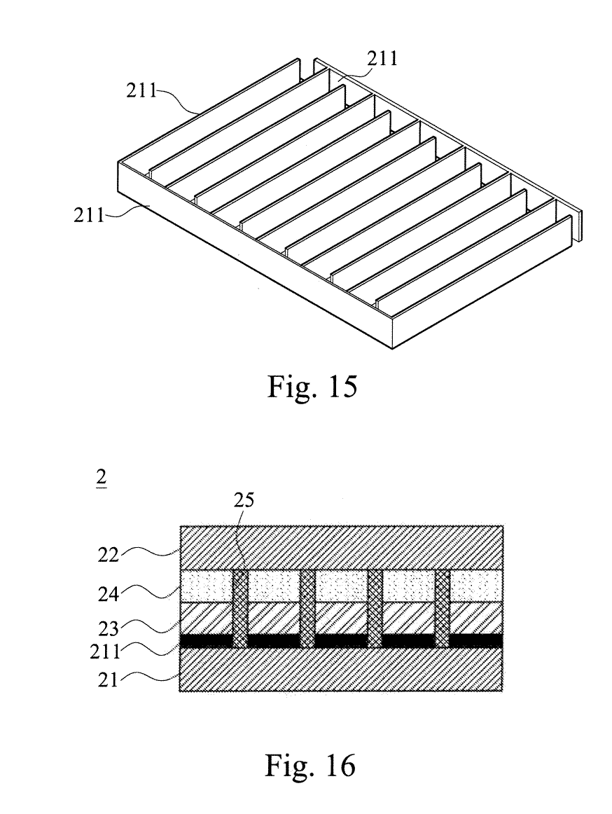

With reference to FIG. 13 for a schematic view of an electrochromic module comes with a plurality of first electrically conductive elements used for isolating the electrochromic module in accordance with a sixth preferred embodiment of the present invention, FIG. 14 for a top view of the electrochromic module of FIG. 13, and FIG. 15 for a perspective view of the electrochromic module of FIG. 13, the electrochromic module comes with a plurality of first electrically conductive elements 211, electrochromic layers 23 and ion layers 24. Since the ion layer 24 is in form of a solution, therefore the first electrically conductive elements 211 can be used for an isolation purpose for storing the ion layer 24 and preventing it from being spilled over. The first electrically conductive elements 211 provide positive and negative voltages sequentially to produce a voltage difference for removing or supplying electrons.

With reference to FIG. 16 for a schematic view of an electrochromic module having a plurality of first electrically conductive elements, electrochromic layers and ion layers, and an isolating unit disposed among them in accordance with a seventh preferred embodiment of the present invention, the ion layers 24 are in form of a solution, therefore an isolating unit 25 disposed among the ion layers 24 can be used for the isolation purpose, and the ion layers 24 can be stored without the risk of being spilled over. The isolating units 25 are photoresists. In this preferred embodiment, the ion layers 24 are ground, and the first electrically conductive elements 211 provide positive and negative voltages to produce a voltage difference for removing or providing electrons.

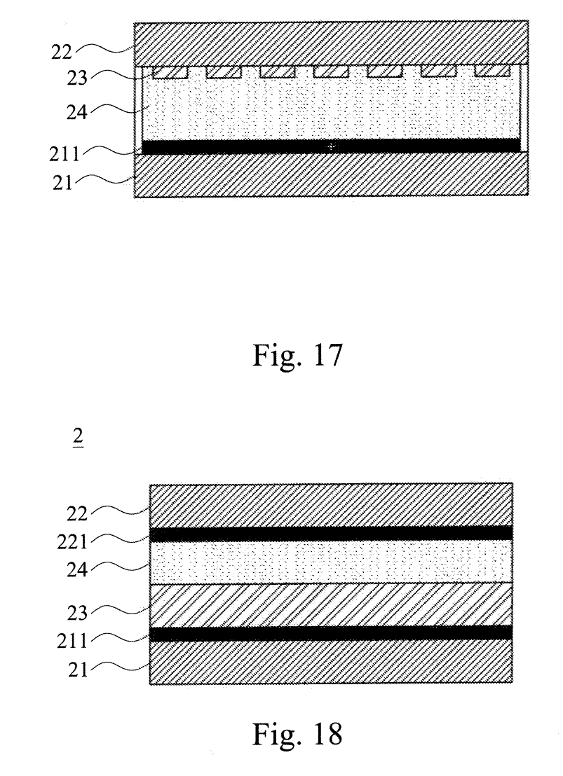

With reference to FIG. 17 for a schematic view of an electrochromic module in accordance with an eighth preferred embodiment of the present invention, the first substrate 21 includes at least one first electrically conductive element 211, and the first electrically conductive element 211 just supplies a positive voltage only, and the electrochromic module comes with a plurality of electrochromic layers 23. Unlike each of the foregoing preferred embodiments, the electrochromic layers 23 also have the function of electrodes, and a negative voltage is supplied to the electrochromic layers 23 in this preferred embodiment, and the selected electrochromic material is conductive polymer such as polyaniline having both electrically conductive and electrochromic functions.

The electrochromic module of the present invention can further comprise at least one second electrically conductive element disposed on a lower surface of the second substrate. The electrochromic module may come with one or more second electrically conductive elements as shown in FIGS. 3 to 16 and used for producing a potential difference, on that it is not necessary to ground the ion layer in these preferred embodiments. The structure of this preferred embodiment is the same as that of the foregoing preferred embodiments, and thus will not be described here again, and the following implementations are provided for reference.

With reference to FIG. 18 for a schematic view of an electrochromic module further having a second electrically conductive element in accordance with a ninth preferred embodiment of the present invention, the electrochromic module 1 further comprises at least one second electrically conductive element 221, disposed on a lower surface of the second substrate 22. The electrochromic module may have one or more second electrically conductive elements 221 disposed on another side, and the first electrically conductive element 211 and the second electrically conductive element 221 can expedite the supply or removal of electron to increase the coloration/decoloration speed of the electrochromic layer 23 and the ion layer 24.

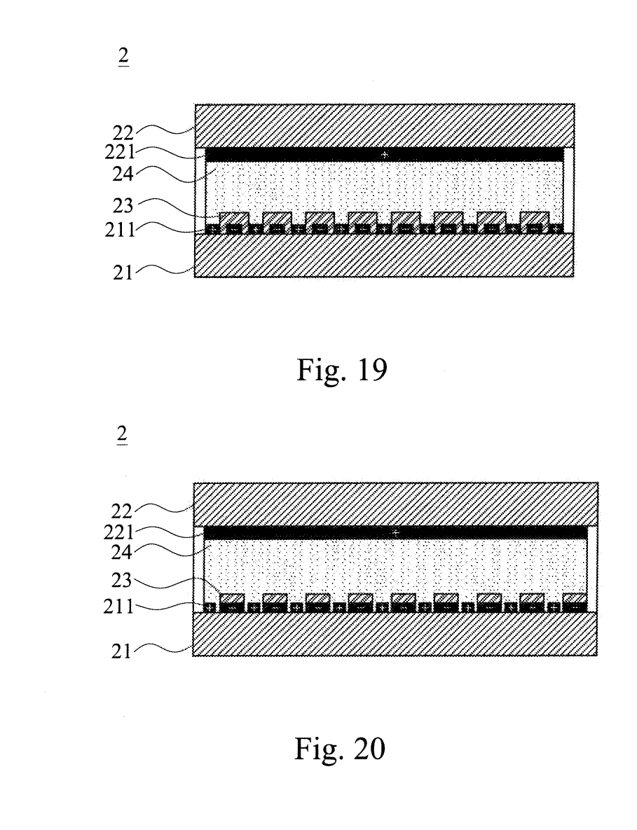

With reference to FIG. 19 for a schematic view of an electrochromic module with a second substrate as depicted in FIG. 9 further having a second electrically conductive element in accordance with a tenth preferred embodiment of the present invention, FIG. 20 for a schematic view of an electrochromic module with a second substrate as depicted in FIG. 10 further having a second electrically conductive element in accordance with an eleventh preferred embodiment of the present invention, the electrochromic module comes with one or more second electrically conductive elements 221, and the first electrically conductive elements 211 provide positive and negative voltages alternately, and the second electrically conductive element 221 provides a positive voltage, such that electrons are pulled and moved by the positive voltage, and the movement of the electrons is limited to restrict the coloration/decoloration range of the ion layer 24.

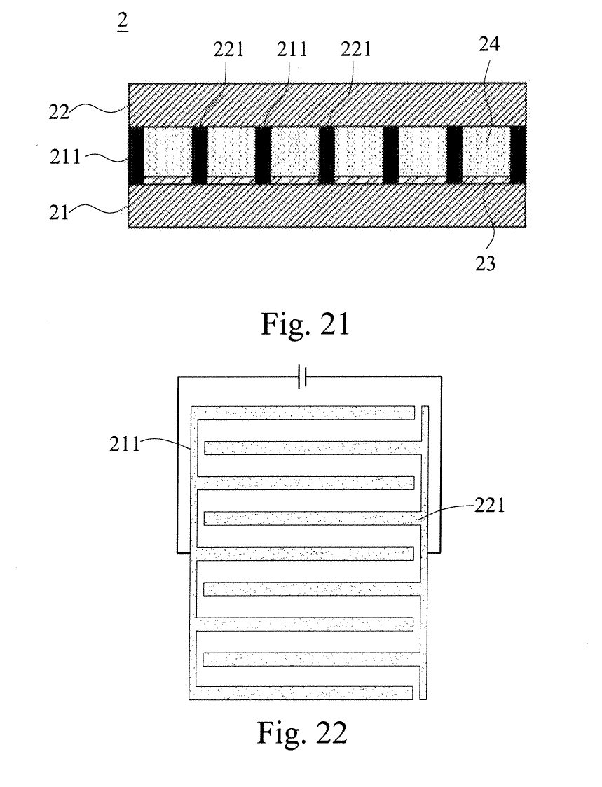

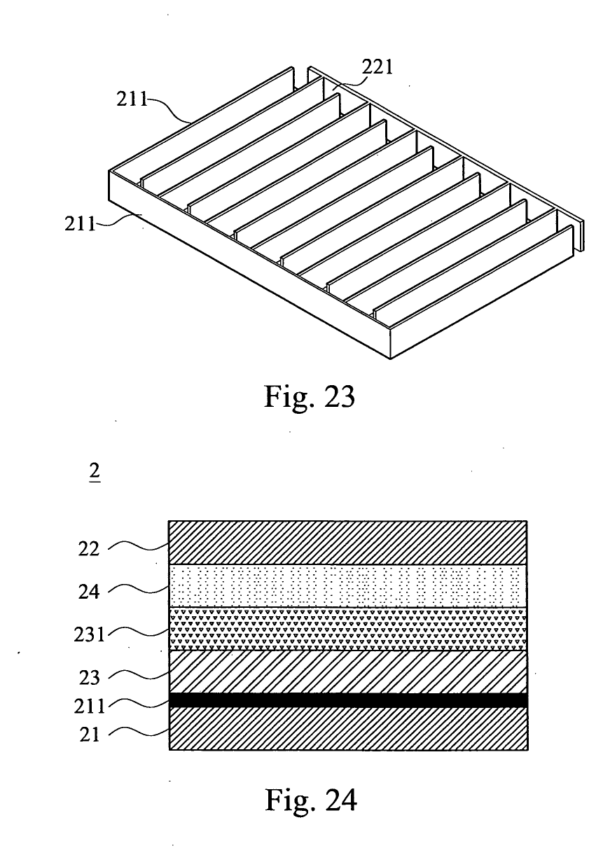

With reference to FIG. 21 for a schematic view of an electrochromic module comes with a plurality of first and second electrically conductive elements installed sequentially and used for isolation in accordance with a twelfth preferred embodiment of the present invention, FIG. 22 for a top view of the electrochromic module of FIG. 21, and FIG. 23 for a perspective view of an electrochromic module as depicted in FIG. 21, this preferred embodiment also uses the first electrically conductive element 211 for the isolation purpose similar to that illustrated in FIG. 13, and the first electrically conductive elements 211 and the second electrically conductive elements 221 are installed between the ion layers 24 alternately for the isolation purpose and preventing the electrically conductive elements 211, 221 from being spilled over.

The concept of each of the foregoing preferred embodiment is to control the electric field to isolate image cross-talks caused by the color change of the ion layer 24. In the foregoing preferred embodiments, interdigitated electrodes are preferred. For example, the first electrically conductive elements 211 and the second electrically conductive elements 221 are arranged alternately and used as anode and cathode respectively, and the position at wherein the color change of the ion layer 24 takes place can be restricted at the position of the cathode of the second electrically conductive element 221 effectively.

Each component of the aforementioned electrochromic module 2 comprises the first substrate 21, the first electrically conductive element 211, the second substrate 22, the second electrically conductive element 221, the electrochromic layer 23 and the ion layer 24, which will be described below.

The first transparent substrate 21 and the second transparent substrate 22 are made of a plastic, polymer plastic or glass material, or a plastic polymer selected from the collection of resin, polyethylene terephthalate (PET), polycarbonate (PC), polyethylene (PE), polyvinyl chloride (PVC), polypropylene (PP), polystyrene (PS), and polymethylmethacrylate (PMMA); and the first transparent conductive element 211 and the second transparent conductive element 221 are made of an impurity-doped oxide selected from the collection of indium tin oxide (ITO), indium zinc oxide (IZO), Al-doped ZnO (AZO) and antimony tin oxide (ATO) or carbon nanotubes.

The first electrically conductive element 211 and the second electrically conductive element 221 are made of an impurity-doped oxide selected from the collection indium tin oxide (ITO), indium zinc oxide (IZO), al-doped ZnO (AZO) and antimony tin oxide (ATO) or an electrically conductive polymer material such as carbon nanotube and poly-3,4-ethylenedioxythiophene (PEDOT).

The electrochromic layer 23 is made of an organic electrochromic material, an inorganic electrochromic material, a transition metal oxide, a transition metal compound or a composite material of the transition metal compound and the organic electrochromic material, and coated by a sol-gel method, a sputtering method, a plating method, a screen printing method, a spraying method, an anodizing method, a photopolymerization method, a laser etching method, an electrophoresis method or an electrochemical synthesis/deposition method.

The organic electrochromic material is a redox compound such as bipyridyls, viologen, anthraquinone, tetrathiafulvalene and pyrazolone, or their derivatives; or polyacetylene, polyaniline, polypyrrole, polythiophene, poly-3-alkylthiophene, polyfuran, polyphenylene, aromatic polyamide/polyimide, or an electrically conductive polymer such as polyphenylenevinylene and its derivative; or a polymeric metal complex and its derivatives; or a coordination complex of a transition metal and lanthanide element and their derivatives; or zinc phthalocyanine and its derivatives; or ferrocene and iron(III) thiocyanate dissolved in water solution, hexacyanoferrate dissolved in tetracyanoquino solution or tetrasulfur cyanide dissolved in acetonitrile.

The transition metal oxide is an anodic coloration transition metal oxide selected from the collection of chromium oxide (Cr₂O₃), nickel oxide (NiOₓ) iridium oxide (IrO₂), maganese oxide (MnO₂), nickel hydroxide Ni(OH)₂ and tantalum pentoxide (Ta₂O₅), or a cathodic coloration transition metal oxide selected from the collection of tungsten oxide (WO₃), molybdenum oxide (MoO₃), niobium oxide (Nb₂O₃), titanium oxide (TiO₂), strontium titanium oxide (SrTiO₃) and tantalum pentoxide (Ta₂O₅); or a cathodic/anodic coloration transition metal oxide selected from the collection of vanadium oxide (V₂O₂), rhodium oxide (Rh₂O₃) and cobalt oxide (CoOₓ).

The transition metal compound is Prussian blue (Fe₄[Fe(CN)₆]₃).

The inorganic electrochromic material is a Li, K, Mg, Cr, Cu, or Ba doped C60 thin film.

The organic material of the ion layer 24 is a redox indicator or a pH indicator (or an acid-base indicator). The redox indicator is an indicator used for a redox titration and capable of producing a significant color change at a specific electrode potential. In general, the organic testing agent with a redox property has a different color at an oxidation state or a reduction state, and there are two common types of redox indicators, respectively: a metal organic coordination compound and an organic redox system. Almost all redox indicators and redox systems are related to protons (H⁺) and used as a participant of an electrochemical reaction, such that the redox indicator can be divided by the aforementioned characteristic into two types: a pH dependent redox indicator and a pH independent redox indicator. The pH independent redox indicator includes: 2,2′-bipyridine coordination ion, 5-ferroin coordination ion, N-phenyl-o-anthranilic acid, 1,10-phenanthroline-ferrous coordination ion, erioglaucine disodium salt, paraquat, 2,2′-dipyridyl-ferrous coordination ion, 5,6-dimethyl ferroin coordination ion, 3,3′-dimethoxybenzidine, sodium diphenylamine sulfonate, N,N′-diphenylbenzidine, N-phenylaniline, methyl viologen, but some of the aforementioned indicators are toxic; and the pH dependent redox indicator includes: dichlorophenolindophenol sodium, methylndophenol sodium, thionine, methylene blue, indigo tetrasulfonic acid, indigo trisulfonic acid, indigo carmine, indigo monosulfonic acid, phenyl red, safranin T, and neutral red. The pH indicator (acid-base indicator) is used for testing a pH value of a chemical testing agent, and the pH indicator is a weak acid or a weak alkali containing a pigment, and the pigment will be combined with hydrogen ions or hydroxide ions to become a corresponding acidic or alkaline form to show a different color when the pH indicator is dropped into a solution. Since the pH indicator produces a reversible color change when the pH indicator is dropped into a solution with a different pH value, therefore it can indicate the end of a reaction in a neutralization analysis and measure the pH value of the testing solution. The common pH indicator used in a laboratory includes: phenolsulfonphthalein, Congo red, methyl orange, phenol, thymol blue, litmus, methyl purple, malachite green, methyl yellow, bromophenol blue, bromocresol green, methyl red, bromocresol purple, bromothymol blue, thymolphthalein, mordant orange R.

The redox indicator of the ion layer of the present invention is preferably methylene blue (C₁₆H₁₈ClN₃S.3H₂O), dichlorophenolindophenol sodium (C₁₂H₆Cl₂NNaO₂), N-phenyl-o-anthranilic acid (C₁₃H₁₁NO₂), sodium diphenylamine sulfonate (C₁₂H₁₀NNaO₃S), N,N′-diphenylbenzidine (C₂₀H₂₀N₂) or methyl viologen, and the pH indicator is preferably a variamine blue B diazonium salt (C₁₃H₁₂ClN₃O).

The inorganic material of the ion layer 24 is an inorganic derivative.

The inorganic derivative is one selected from a halogen group (VIIA), an oxygen group (VIA), a nitrogen group (VA), a carbon group (IVA), a boron group (IIIA), an alkali earth metal group (IIA) or an alkali metal group (IA); or an oxide, a sulfide, a chloride or a hydroxide of a transition element.

The transition element is one selected from the collection of a scandium subgroup (IIIB), a titanium subgroup (IVB), a vanadium subgroup (VB), a chromium subgroup (VIB), a manganese subgroup (VIIB), an iron series (VIII), a copper subgroup (IB), a zinc subgroup (IIB) and a platinum series (VIII).

Each of the aforementioned groups is described as follows:

Halogen Group (VIIA):

Solid: I2 purplish black; ICl dark red; IBr dark grey; IF3 yellow; ICl₃ orange; I₂O₅ white; I₂O₄ yellow (ion crystal); I₄O₉ yellow (ion crystals).

Oxygen Group (VIA):

Solid: S light yellow; Se grey, brown; Te colorless metal luster; Na₂S, (NH₄)₂S, K₂S, BaS white, soluble; ZnS white↓; MnS red flesh↓; FeS black↓; PbS black↓; CdS yellow↓; Sb₂S₃ orange red↓; SnS brown↓; HgS black (precipitate), red (cinnabar red); Ag₂S black↓; CuS blackl↓; Na₂S₂O₃ white; Na₂S₂O₄ white; SeO₂ white, volatile; SeBr₂ red; SeBr₄ yellow; TeO₂ white heated to become yellow; H₂TeO₃ white; TeBr₂ brown; TeBr₄ orange; TeI₄ grayish black; PoO₂ low-temperature yellow (face-centered cube), high-temperature red (tetrahedron); SO₃ colorless; SeO₃ colorless easily soluble in water; TeO₃ orange; H₆TeO₆ colorless.

Nitrogen Group (VA):

Solid: ammonium salt colorless crystal; nitrified metal white; N₂O₃ blue (low-temperature); N₂O₅ white; P white, red, black; P₂O₃ white; P₂O₅ white; PBr₃ yellow; PI₃ red; PCl₅ colorless; P₄Sx yellow; P₂S₃ grayish yellow; P₂S₅ light yellow; H₄P₂O₇ colorless glass form; H₃PO₂ white; As grey; As₂O₃ white; As₂O₅ white; AsI₃ red; As₄S₄ red (arsenic disulfide); As₄S₆ yellow (arsenic trisulphide); As₂S₅ light yellow; Sb silver white; Sb(OH)₃ white↓; Sb₂O₃ white (antimony white pigment); Sb₂O₅ light yellow; SbX₃(X⋄I) white; SbI₃ red; Sb₂S₃ orange red↓; Sb₂S₅ orange yellow; Bi silver white and slightly red; Bi₂O₃ light yellow; Bi₂O₅ reddish brown; BiF₃ grayish white; BiCl₃ white; BiBr₃ yellow; BiI₃ black↓; Bi₂S₃ brownish black.

Carbon Group (IVA):

Solid: C (corundum) colorless transparent; C (graphite) black color metal luster; Si grayish black color metal luster; Ge grayish white; Sn silver white; Pb dark grey; SiO₂ colorless transparent; H₂SiO₃ colorless transparent gel↓; Na₂SiF₆ white crystal; GeO black; GeO₂ white; SnO black; SnO₂ white; Sn(OH)₂ white↓; PbO yellow or yellowish red; Pb₂O₃ orange; Pb₃O₄ red; PbO₂ brown; CBr₄ light yellow; CI₄ light red; GeI₂ orange; GeBr₂ yellow; GeF₄ white; GeBr₄ grayish white; GeI₄ yellow; SnF₂ white; SnCl₂ white; SnBr₂ light yellow; SnI₂ orange; SnF₄ white; SnBr₄ colorless; SnI₄ red; PbF₂ colorless↓; PbCl₂ white↓; PbBr₂ white; PbI₂ gold yellow; PbF₄ colorless; GeS red; GeS₂ white; SnS brown↓; SnS₂ gold yellow (commonly called gold powder)↓; PbS black↓; PbS₂ reddish brown; Pb(NO₃)₂ colorless; Pb(Ac)₂.3H₂O colorless crystal; PbSO₄ white↓; PbCO₃ white↓; Pb(OH)₂ white↓; Pb₃(CO₃)₂(OH)₂ lead white↓; PbCrO₄ white yellow↓.

Boron Group (IIIA):

Solid: B (with no fixed shape) brown powder; B (crystal) grayish black; Al silver white; Ga silver white (easily liquefied); In silver grey; Tl silver grey; B₂O₃ glass form; H₃BO₃ colorless sheet form; BN white; Na₂B₄O₇.10H₂O white crystal; Cu(BO₂)₂ blue↓; Ni(BO₂)₂ green↓; NaBO₂.Co(BO₂)₂ blue↓; NaBO₂.4H₂O colorless crystal; non-aqueous NaBO₂ yellow crystal; Al₂O₃ white crystal; AlF₃ colorless; AlCl₃ white; AlBr₃ white; AlI₃ brown; Al(OH)₃ white↓; Ga₂O₃ white↓ Ga(OH)₃ white↓; GaBr₃ white; GaI₃ yellow; In₂O₃ yellow; InBr₃ white; InI₃ yellow; TlOH yellow; Tl₂O black; Tl₂O₃ brownish black; TlCl white↓; TlBr light yellow↓; TlI yellow↓ (similar to silver); TIBr₃ yellow; TlI₃ black.

Alkali Earth Metal (IIA):

Elementary substance: silver white

Flame color: Ca brick red; Sr magneta; Ba green.

Oxides: All oxides are white solids.

Hydroxides: White solids Be(OH)₂↓, Mg(OH)₂↓.

Salts: Most salts are colorless or white crystals; BeCl₂ light yellow; BaCrO₄ yellow↓; CaF₂ white↓.

Alkali Metal (IA):

Elementary substance: silver white

Flame color: Li red; Na yellow; K purple; Rb purplish red; Cs purplish red.

Oxide, Peroxide, Super Oxide, Ozonide: Li₂O white; Na₂O white; K₂O light yellow; Rb₂O white yellow; Cs₂O orange red; Na₂O₂ light yellow; KO₂ orange yellow; RbO₂ dark brown; CsO₂ dark yellow; KO₃ orange red.

Hydroxide: white, LiOH white↓.

Salt: Most salts are colorless or white crystals and easily soluble in water.

Insoluble salt↓ (all are white crystals unless otherwise stated): LiF Li₂CO₃ Li₃PO₄ LiKFeIO₆ Na[Sb(OH)₆]NaZn(UO₂)₃(Ac)₉.6H₂O yellow green; M=K,Rb,Cs M₃[Co(NO₂)₆] white yellow; MBPh₄ MClO₄ M₂PtCl₆ light yellow; CsAuCl₄.

Copper Subgroup (IB):

Elementary substance: Cu purplish red or dark red; Ag silver white; Au gold yellow.

Copper compound: Flame color green; CuF red; CuCl white↓; CuBr yellow↓; CuI brownish yellow↓; CuCN white↓; Cu₂O dark red; Cu₂S black; CuF₂ white; CuCl₂ brownish yellow (yellowish green solution); CuBr₂ brown; Cu(CN)₂ brownish yellow; CuO black↓; CuS black↓; CuSO₄ colorless; CuSO₄.5H₂O blue; Cu(OH)₂ light blue↓; Cu(OH)₂.CuCO₃ green black; [Cu(H₂O)₄]²⁺ blue; [Cu(OH)₄]²⁻ bluish purple; [Cu(NH3)₄]²⁺ dark blue; [CuCl₄]²⁻ yellow; [Cu(en)₂]²⁺ dark bluish purple; Cu₂[Fe(CN)₆] brown red; cuprous acetylide red↓.

Silver compound: AgOH white (decomposed at normal temperature); Ag₂O black; freshly made AgOH brownish yellow (mixed with Ag₂O); silver proteinate (AgNO₃ dropped on hands) black↓; AgF white; AgCl white↓; Ag bright yellow↓; AgI yellow↓ (gel); Ag₂Sblack↓; Ag₄[Fe(CN)₆] white↓; Ag₃[Fe(CN)₆] white↓; Ag⁺, [Ag(NH₃)₂]⁺, [Ag(S₂O₃)₂]³⁻, [Ag(CN)₂]⁻ colorless.

Gold compound: HAuCl₄.3H₂O white yellow crystal; KAuCl₄.1.5H₂O colorless sheet crystal; Au₂O₃ black; H[Au(NO₃)₄].3H₂O yellow crystal; AuBr grayish yellow↓; AuI lemon yellow↓.

Zinc Subgroup (IIB):

Elementary substance: All elementary substances are silver white, and the Hg precipitate in water solution is black.

Zinc compound: ZnO white (zinc white pigment); ZnI2 colorless; ZnS white↓; ZnCl₂ white crystal (highly soluble, water-soluble, acidic); K₃Zn₃[Fe(CN)₆] white; Zn₃[Fe(CN)₆]₂ yellowish brown.

Cadmium compound: CdO brownish grey↓; CdI₂ yellow; CdS yellow (cadmium yellow pigment)↓; HgCl₂ (mercury perchloride) white; HgNH₂Cl white↓; Hg₂Cl₂(mercurous chloride) white↓.

Mercury compound: HgO red (large crystal grain) or yellow (small crystal grain)↓; HgI₂ red or yellow (slightly soluble); HgS black or red↓; Hg₂NI.H₂O red↓; Hg₂(NO₃)₂ colorless crystal.

ZnS phosphor: Ag blue; Cu yellowish green; Mn orange.

Titanium Subgroup (IVB):

Titanium compound: Ti3⁺ purplish red; [TiO(H₂O₂)₂]²⁺ orange yellow; H₂TiO₃ white↓; TiO₂ white (titanium white pigment) or Mona red (rutile)↓; (NH₄)₂TiCl₆ yellow crystal; [Ti(H₂O)₆]Cl₃ purple crystal; [Ti(H₂O)₅Cl]Cl₂.H₂O green crystal; TiCl₄ colorless smoke-generating liquid.

Zirconium, hafnium: MO₂, MCl₄ white.

Vanadium Subgroup (VB):

Vanadium compound: V²⁺ purple; V³⁺ green; VO²⁺ blue; V(OH)⁴⁻ yellow; VO4³⁻ yellow; VO black; V₂O₃ grayish black; V₂S₃ brownish black; VO₂ blue solid; VF₄ green solid; VCl₄ dark brown liquid; VBr₄ magneta liquid; V₂O₅ yellow or brick red; hydrate V₂O₅ brownish red; saturated V₂O₅ solution (slightly soluble) light yellow; [VO₂(O₂)₂]³⁻ yellow; [V(O₂)₃]³⁻ reddish brown.

Vanadium acid radical polycondensation: As the atomic number of vanadium reduces, the color changes from a light yellow to dark red˜light yellow.

Columbium, tantalum: omitted.

Chromium Subgroup (VIB):

Chromium compound: Cr²⁺ blue; Cr3⁺ purple; Cr₂O₇²⁻ orange red; CrO₄²⁻ yellow; Cr(OH)⁴⁻ bright green; Cr(OH)₃ grayish blue; Cr₂O₃ green; CrO₃ dark red needle shape; [CrO(O₂)₂]OEt₂ blue; CrO₂Cl₂ dark red liquid; Na₂Cr₂O₇, K₂CrO₇ orange red; Ag₂CrO₄ brick red↓; BaCrO₄ yellow↓; PbCrO₄ yellow↓.

Purplish red Cr₂(SO₄)₃.18H2O→Green Cr₂(SO₄)₃.6H₂O→Peach redCr₂(SO₄)₃

Dark green [Cr(H₂O)₄Cl₂]Cl-cooling HCl→purple [Cr(H₂O)₆]Cl₃-ethylether HCl→light green [Cr(H₂O)₅Cl]Cl₂

[Cr(H₂O)₆]³⁺ purple; [Cl (H₂O)₄(NH₃)₂]³⁺ purplish red; [Cr(H₂O)₃(NH3)₃]³⁺ light red; [Cr(H₂O)₂(NH₃)₄]³⁺ orange red; [Cr (NH₃)₅H₂O]³⁺ orange yellow; [Cr(NH₃)₆]³⁺ yellow.

Molybdenum, tungsten: MoO₃ white; brown MoCl₃; green MoCl₅; MoS₃ brown↓; (NH₄)₃[P(MO₁₂O₄₀)].6H₂O yellow crystal form↓; WO₃ dark yellow; H₂WO₄.xH₂O white gel.

Manganese Subgroup (VIIB):

Manganese compound: Mn²⁺ flesh red; Mn³⁺ purplish red; MnO₄²⁻ green; MnO⁴⁻ purple; MnO³⁺ bright green; Mn(OH)₂ white↓; MnO(OH)₂ brown↓; MnO₂ black↓; non-aqueous manganese salt (MnSO₄) white crystal; hexahydrate manganese salt (MnX₂.6H₂O, X=halogen, NO₃, ClO₄) pink; MnS.nH₂O flesh red↓; non-aqueous MnS dark green; MnCO₃ white↓; Mn₃(PO₄)₂ white↓; KMnO₄ purplish red; K₂MnO₄ green; K₂[MnF₆] gold yellow crystal; Mn₂O₇ brown oily liquid.

Technetium, Rhenium: omitted.

Iron Series (Group VIII of Fourth Period):

Iron compound: Fe²⁺ light green; [Fe(H₂O)₆]³⁺ light purple; [Fe(OH)(H₂O)₅]²⁺ yellow; FeO₄²⁻ purplish red; FeO black; Fe₂O₃ dark red; Fe(OH)₂ white; Fe(OH)₃ brownish red↓; FeCl₃ or FeCl₂ crystal brown red blue; non-aqueous FeSO₄ white; FeSO₄.7H₂O green; K₄[Fe(CN)₆](yellow prussiate) yellow crystal; K₃[Fe(CN)₆](red prussiate) red crystal; Fe₂[Fe(CN)₆] Prussian blue ↓; Fe[Fe(CN)₆]black↓; Fe(C₅H₅)₂ (ferrocene) orange yellow crystal; M₂Fe₆(SO₄)₄(OH)₁₂(yellow ferrous sulfate, M=NH₄, Na, K) light yellow crystal; Fe(CO)₅ yellow liquid.

Cobalt compound: Co²⁺ pink; CoO grayish green; CO₃O₄ black; Co(OH)₃ brown↓; Co(OH)₂ pink↓; Co(CN)₂ red; K₄[Co(CN)₆] purple crystal; CO₂(CO)₈ yellow crystal; [Co(SCN)₆]⁴⁻ purple;

Cobalt chloride is dehydrated into pink CoCl₂.6H₂O-325K-purplish red CoCl.2H₂O-313K→bluish purple CoCl₂.H₂O-393K→blue CoCl₂.

Nickel compound: Ni²⁺ bright green; [Ni(NH₃)₆]²⁺ purple; Ni(OH)₂ green ↓; Ni(OH)₃ black↓; non-aqueous Ni(II) salt yellow; Na₂[Ni(CN)₄] yellow; K₂[Ni(CN)₄] orange; Ni(CO)₄ colorless liquid.

Platinum Series Element (Group VIII of Fifth and Sixth Periods):

Os bluish grey volatile solid; Pd↓(aq) black; OsO₄ colorless special-odor gas; H₂PtCl₆ orange red crystal; Na₂PtCl₆ orange yellow crystal; M₂PtCl₆(M=K, Rb, Cs, NH₄) yellow↓.

The ion layer 24 is preferably made of an inorganic material such as ferrous chloride (FeCl₂), ferric trichloride FeCl₃), titanium trichloride (TiCl₃), titanium tetrachloride (TiCl₄), bismuth chloride (BiCl₃), copper chloride (CuCl₂) or lithium bromide (LiBr).

In addition, the ion layer 24 further includes at least one inert conductive salt, and the conductive salt is a lithium salt, a sodium salt or a tetraalkylammonium salt. The applicable anion of the aforementioned conductive salts provides the redox inertness of the metallic salt, and the colorless anion can be a tetrafluoroborate ion, a tetraphenylborate ion, a cyanophenylborate ion, a tetramethoxyborate ion, a perchlorate ion, a chloride ion, a nitrate ion, sulfate ion, a phosphate ion, a methanesulfate ion, an ethanesulfate ion, a tetradecylsulfate ion, a pentadecanesulfonate ion, a trifluoromethanesulfonate ion, a perfluorobutane sulfonate ion, a perfluorooctane sulfonate ion, a benzene sulfonate ion, a chlorobenzenesulfonate ion, a toluene sulfonate ion, a butylbenzene sulfonate ion, a tert-butylbenzene sulfonate ion, a dodecylbenzene sulfonate ion, a trifluoromethylbenzene sulfonate ion, a hexafluorophosphate ion, a hexafluoroarsenate ion, or a hexafluorosilicate ion.

The solvent of the ion layer 24 is dimethyl sulfoxide [(CH₃)₂SO], propylene carbonate (C₄H₆O₃), water (H₂O), γ-butyrolactone, acetonitrile, propionitrile, benzonitrile, glutaronitrile, methylglutaronitrile, 3,3′-oxy-2-propionitrile, hydroxyl propionitrile, dimethyl-formamide, N-methylpyrrolidone, sulfone, 3-methyl sulfone or their mixtures.

When the ion layer 24 is used for assisting the color change or used as another coloration layer, its coloration mechanism is described as follows: ferrous chloride (FeCl₂) and methylene blue are dissolved in dimethyl sulfoxide (DMSO) to produce an electrochromic solution of a complementary system, and ferrous chloride crystal particles are in blue color (since Fe²⁺ is blue), and the oxidized surface is in a reddish brown color (since Fe³⁺ is light yellow), and ferrous chloride is dissolved in a solvent, and Fe²⁺ is oxidized to form Fe³⁺, such that the solvent becomes light yellow. The first transparent electrically conductive element 211 supplies electrons, such that when methylene blue molecules approaching to the first transparent electrically conductive element 211 obtain electrons to produce a reduction, the methylene blue becomes a free radical, and when the external voltage is removed, Fe³⁺ is a methylene blue free radical with a different electric potential energy level, and electrons will be transmitted from the methylene blue free radical to Fe³⁺, so that the light yellow Fe³⁺ is reduced to the blue Fe²⁺, and the whole ion layer 24 changes its color from light yellow to blue due to the change of valence, so as to achieve a dark color change effect. The color display effect of the ion layer 24 can be controlled by adjusting the concentration, potential difference, solvent polarity, pH value, electrode gap and dielectric constant of the electrochromic solution.

To achieve a better effect, the color of the electrochromic grating of this preferred embodiment is preferably black, grayish black, brownish black or dark brown, and has a light transmittance below 20%. To achieve such a dark color, it generally requires a higher voltage, so that the life of the electrochromic layer 23 may be reduced easily. With the concepts of a complementary color change of the electrochromic layer 23 and the ion layer 24 and a different RGB combination, a low driving voltage can produce the dark color effect.

To achieve the light shielding effect for the aforementioned black, grayish black, brownish black or dark brown color, the present invention stacks a plurality of electrochromic layers together to achieve the effect of color complements. With reference to FIG. 24 for a schematic view of an electrochromic module having two electrochromic layers stacked with each other in accordance with a thirteenth preferred embodiment of the present invention, the electrochromic layer 23 further includes another electrochromic layer 231. For example, the ion layer 24 is made of a liquid electrochromic material containing phenothiazine having a green coloration state, and the electrochromic layer 23 is made of cobalt oxide (CoOx) having a red coloration state, and the electrochromic layer 231 is made of Prussian blue Fe₄[Fe(CN)₆]₃ having a blue or brown coloration state, and the light shielding effect can be achieved by mixing the three colors respectively: green, red and blue; or the electrochromic layer 23 and the electrochromic layer 231 are made of a material selected from Prussian blue Fe₄[Fe(CN)₆]₃ and vanadium pentoxide (V₂O₅), and the coloration state of vanadium pentoxide is grey, and the light shielding effect can be achieved by mixing the dark blue and grey colors; or selected from Fe₄[Fe(CN)₆]₃ and Fe₄[Ru(CN)₆]₃, and the coloration state of Fe₄[Ru(CN)₆]₃ is purple, and the light shielding effect can be achieved by mixing the blue and purple colors.

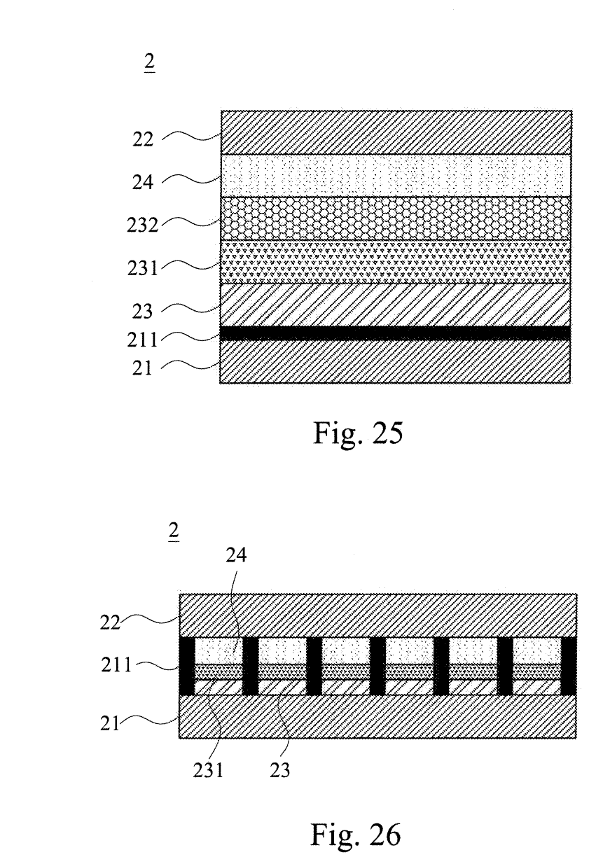

With reference to FIG. 25 for a schematic view of an electrochromic module having three electrochromic layers stacked with each other in accordance with a fourteenth preferred embodiment of the present invention, the electrochromic layer 231 of the thirteenth preferred embodiment further includes an electrochromic layer 232, and the color change of a multiple of layers of the electrochromic material is used to the color mixing to achieve a better light shielding effect of the dark colors.

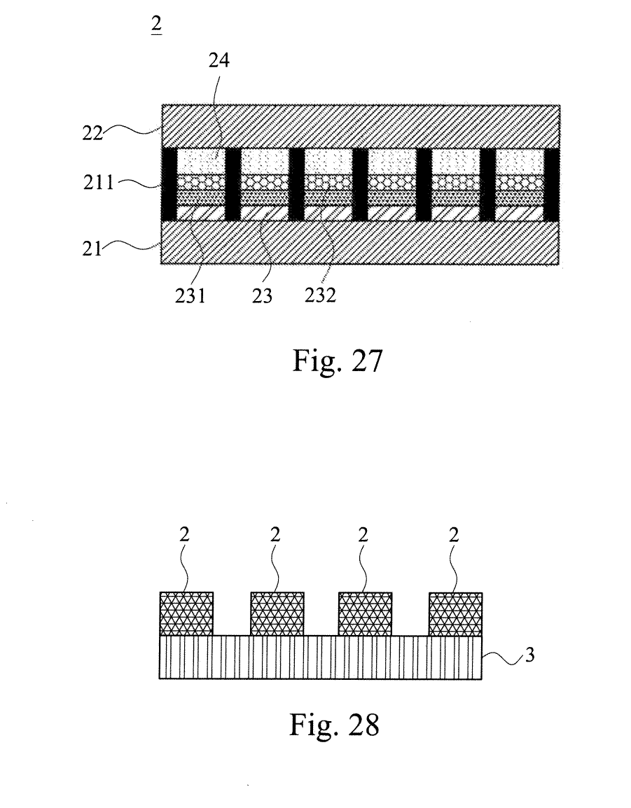

With reference to FIGS. 26 and 27 for schematic views of electrochromic modules of the thirteenth and fourteenth preferred embodiments combined with the design of the sixth preferred embodiment of the present invention respectively, the electrochromic layer has a multilayer design that can be applied to any of the aforementioned implementations of the electrochromic module.

With reference to FIG. 28 for a schematic view of an electrochromic module having a plurality of electrochromic modules installed to a stereo image display device of an image display module in accordance with a fifteenth preferred embodiment of the present invention, the stereo image display device includes an image display module 3 for displaying a planar image and a stereo image; and a plurality of electrochromic modules 2 installed on a surface of the image display module 3. The structure of the electrochromic modules 2 is the same as those of electrochromic modules described in each of the foregoing preferred embodiments, and thus will not be described here again. If it is necessary to display a stereo image, a negative voltage is applied to the electrochromic modules 2, such that its colorations can be used for the grid purpose and left and right eyes can receive different images to produce a parallax, and finally the brain combines the images into a stereo image. If it is necessary to display a planar image, a positive voltage is applied to the electrochromic modules 2 for the decoloration, so that the grid will disappear.

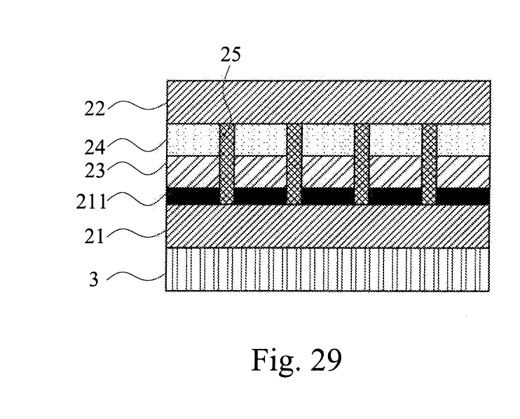

Alternatively, the method as illustrated in FIG. 29 can be adopted. With reference to FIG. 29 for a schematic view of an electrochromic module of FIG. 16 installed to a stereo image display device of an image display module in accordance with a sixth preferred embodiment of the present invention, the stereo image display device includes an image display module 3 for displaying a planar image and a stereo image, and an electrochromic module 2 installed on a surface of the image display module 3, wherein the electrochromic module 2 includes a plurality of electrochromic layers 23. The structure of the electrochromic module 2 is the same as those having a plurality of electrochromic layers 23 of the electrochromic module in each of the foregoing preferred embodiments, and thus will not be described here again. If it is necessary to display a stereo image, a negative voltage is applied to the electrochromic modules 2, such that the coloration of the electrochromic layers 23 can be used for the grid purpose and left and right eyes can receive different images to produce a parallax and finally the brain combines the images into a stereo image. If it is necessary to display a planar image, a positive voltage is applied to the electrochromic modules 2 for the decoloration, so that the grid will disappear.

While the invention has been described by means of specific embodiments, numerous modifications and variations could be made thereto by those generally skilled in the art without departing from the scope and spirit of the invention set forth in the claims.

In summation of the description above, the electrochromic unit and stereo image display device having the electrochromic unit in accordance with the present invention complies with the patent application requirements, and thus is duly filed for patent application.

While the invention has been described by means of specific embodiments, numerous modifications and variations could be made thereto by those generally skilled in the art without departing from the scope and spirit of the invention set forth in the claims.

What is claimed is:

1. An electrochromic module, comprising:
a first substrate, having at least one first electrically conductive element disposed on an upper surface of the first substrate;
a second substrate;
at least one electrochromic layer, disposed between the first substrate and the second substrate; and
at least one ion layer, disposed on a surface of the electrochromic layer, and made of a material prepared by mixing and dissolving at least one organic material and at least one inorganic material dissolved into a solvent.

2. The electrochromic module of claim 1, wherein when the electrochromic module comes with a plurality of first electrically conductive elements, electrochromic layers and ion layers, each first electrically conductive element is in form of a containing slot for containing the electrochromic layers and the ion layers.

3. The electrochromic module of claim 1, wherein when the electrochromic module comes with a plurality of first electrically conductive elements, electrochromic layers and ion layers, the electrochromic module further comprises a plurality of isolating units installed among the first electrically conductive elements, the electrochromic layers and the ion layers.

4. The electrochromic module of claim 3, wherein the isolating units are photoresists.

5. The electrochromic module of claim 1, wherein when the electrochromic module comes with a plurality of first electrically conductive elements and electrochromic layers, the first electrically conductive elements provide positive and negative voltages alternately, and the electrochromic layers are in form of a containing slot for containing the first electrically conductive elements that carry negative electricity.

6. The electrochromic module of claim 1, wherein when the electrochromic module comes with a plurality of first electrically conductive elements and electrochromic layers, the first electrically conductive elements provide positive and negative voltages alternately, and the electrochromic layers are respectively disposed on the first electrically conductive elements that carry negative electricity.

7. The electrochromic module of claim 1, further comprising at least one second electrically conductive element corresponding to the first electrically conductive element and disposed on a lower surface of the second substrate.

8. The electrochromic module of claim 7, wherein when the electrochromic module comes with a plurality of first electrically conductive elements, second electrically conductive elements, electrochromic layers and ion layers, each of the first electrically conductive elements and second electrically conductive element is in form of a containing slot for containing the electrochromic layer and ion layer.

9. The electrochromic module of claim 7, wherein when the electrochromic module comes with a plurality of first electrically conductive elements, second electrically conductive elements, electrochromic layers and ion layers, the electrochromic module further comprises a plurality of isolating units installed among the first electrically conductive elements, the second electrically conductive elements, the electrochromic layers and the ion layers.

10. The electrochromic module of claim 9, wherein the isolating units are photoresists.

11. The electrochromic module of claim 7, wherein when the electrochromic module comes with a plurality of first electrically conductive elements and electrochromic layers, the first electrically conductive elements provide positive and negative voltages alternately, and the second electrically conductive element provides a positive voltage, and the electrochromic layers are separately in form of a containing slot for containing the corresponding first electrically conductive elements that carry negative electricity.

12. The electrochromic module of claim 7, wherein when the electrochromic module comes with a plurality of first electrically conductive elements and electrochromic layers, the first electrically conductive elements provide positive and negative voltages alternately, and the second electrically conductive elements provide a positive voltage, and the electrochromic layers are respectively disposed on the first electrically conductive elements that carry negative electricity.

13. The electrochromic module of claim 1, wherein the first substrate and the second substrate are made of a material selected from the collection of plastic, polymer plastic and glass, or a plastic polymer selected from the collection of resin, polyethylene terephthalate (PET), polycarbonate (PC), polyethylene (PE), polyvinyl chloride (PVC), polypropylene (PP), polystyrene (PS) and polymethylmethacrylate (PMMA).

14. The electrochromic module of claim 1, wherein the first electrically conductive element is an impurity-doped oxide selected from the collection of indium tin oxide (ITO), indium zinc oxide (IZO), al-doped ZnO (AZO) and antimony tin oxide (ATO).

15. The electrochromic module of claim 1, wherein the first electrically conductive element is an electrically conductive polymer selected from the collection of carbon nanotube and poly-3,4-ethylenedioxythiophene (PEDOT).

16. The electrochromic module of claim 1, wherein the electrochromic layer is made of an organic electrochromic material, an inorganic electrochromic material, a transition metal oxide, a transition metal compound or a composite of the transition metal compound and the organic electrochromic material.

17. The electrochromic module of claim 16, wherein the organic electrochromic material is a redox compound selected from the collection of bipyridyls, viologen, anthraquinone, tetrathiafulvalene, pyrazolone and their derivatives.

18. The electrochromic module of claim 16, wherein the organic electrochromic material is an electrically conductive polymer selected from the collection of polyacetylene, polyaniline, polypyrrole, polythiophene, poly-3-alkylthiophene, polyfuran, polyphenylene, aromatic polyamide/polyimide, polyphenylenevinylene and their derivatives.

19. The electrochromic module of claim 16, wherein the organic electrochromic material is a polymeric metal complex or its derivative.

20. The electrochromic module of claim 16, wherein the organic electrochromic material is a coordination complex of a transition metal or a lanthanide element, or their derivatives.

21. The electrochromic module of claim 16, wherein the organic electrochromic material is zinc phthalocyanine or its derivative.

22. The electrochromic module of claim 16, wherein the organic electrochromic material is ferrocene or iron(III) thiocyanate dissolved in a water solution, hexacyanoferrate dissolved in a tetracyanoquino solution or tetrasulfur cyanide dissolved in an acetonitrile solution.

23. The electrochromic module of claim 16, wherein the transition metal oxide is an anodic coloration transition metal oxide selected from the collection of chromium oxide (Cr₂O₃), nickel oxide (NiOₓ), iridium oxide (IrO₂), maganese oxide (MnO₂), nickel hydroxide Ni(OH)₂ and tantalum pentoxide (Ta₂O₅).

24. The electrochromic module of claim 16, wherein the transition metal oxide is a cathodic coloration transition metal oxide selected from the collection of tungsten oxide (WO₃), molybdenum oxide (MoO₃), niobium oxide (Nb₂O₃), titanium oxide (TiO₂), strontium titanium oxide (SrTiO₃) and tantalum pentoxide (Ta₂O₅).

25. The electrochromic module of claim 16, wherein the transition metal oxide is a cathodic/anodic coloration transition metal oxide selected from the collection of vanadium oxide (V₂O₂), rhodium oxide (Rh₂O₃) and cobalt oxide (CoOₓ).

26. The electrochromic module of claim 16, wherein the transition metal compound is Prussian blue (Fe₄[Fe(CN)₆]₃).

27. The electrochromic module of claim 16, wherein the inorganic electrochromic material is a Li, K, Mg, Cr, Cu, or Ba doped C60 thin film.

28. The electrochromic module of claim 1, wherein the organic material of the ion layer is a redox indicator or a pH indicator (or an acid-base indicator).

29. The electrochromic module of claim 28, wherein the redox indicator is made of methylene blue (C₁₆H₁₈ClN₃S.3H₂O), dichlorophenolindophenol sodium (C₁₂H₆Cl₂NNaO₂), N-phenyl-o-anthranilic acid (C₁₃H₁₁NO₂), sodium diphenylamine sulfonate (C₁₂H₁₀NNaO₃S), N,N′-diphenylbenzidine (C₂₀H₂₀N₂) or viologen.

30. The electrochromic module of claim 28, wherein the pH indicator is a variamine blue B diazonium salt (C₁₃H₁₂ClN₃O).

31. The electrochromic module of claim 1, wherein the inorganic material of the ion layer is an inorganic derivative.

32. The electrochromic module of claim 31, wherein the inorganic derivative is an oxide, a sulfide, a chloride or a hydroxide of a transition element.

33. The electrochromic module of claim 32, wherein the transition element is one selected from a scandium subgroup (IIIB), a titanium subgroup (IVB), a vanadium subgroup (VB), a chromium subgroup (VIB), a manganese subgroup (VIIB), an iron series (VIII), a copper subgroup (IB), a zinc subgroup (IIB) and a platinum series (VIII).

34. The electrochromic module of claim 31, wherein the inorganic derivative is one selected from a halogen group (VIIA), an oxygen group (VIA), a nitrogen group (VA), a carbon group (IVA), a boron group (IIIA), an alkali earth metal group (IIA) and an alkali metal group (IA).

35. The electrochromic module of claim 1, wherein the inorganic material of the ion layer is made of ferrous chloride (FeCl₂), ferric trichloride (FeCl₃), titanium trichloride (TiCl₃), titanium tetrachloride (TiCl₄), bismuth chloride (BiCl₃), copper chloride (CuCl₂) or lithium bromide (LiBr).

36. The electrochromic module of claim 1, wherein the solvent of the ion layer is dimethyl sulfoxide [(CH₃)₂SO], propylene carbonate (C₄H₆O₃), water (H₂O), γ-butyrolactone, acetonitrile, propionitrile, benzonitrile, glutaronitrile, methyl glutaronitrile, 3,3′-oxy-2-propionitrile, hydroxyl propionitrile, dimethyl-formamide, N-methylpyrrolidone, sulfone, 3-methyl sulfone or their mixtures.

37. The electrochromic module of claim 1, wherein the ion layer further includes at least one inert conductive salt.

38. The electrochromic module of claim 37, wherein the inert conductive salt is a lithium salt, a sodium salt or a tetraalkylammonium salt.

39. The electrochromic module of claim 7, wherein the first electrically conductive element and the second electrically conductive element are made of an impurity-doped oxide selected from the collection of indium tin oxide (ITO), indium zinc oxide (IZO), al-doped ZnO (AZO) and antimony tin oxide (ATO).

40. The electrochromic module of claim 7, wherein the first electrically conductive element and the second electrically conductive element are made of carbon nanotubes or electrically conductive polymer of poly-3,4-ethylenedioxythiophene (PEDOT).

41. A stereo image display device, comprising:
an image display module, for displaying a planar image and a stereo image; and
an electrochromic module, disposed on a surface of the image display module, and comprising:
a first substrate, having at least one first electrically conductive element disposed on an upper surface of the substrate;
a second substrate;
a plurality of electrochromic layers, formed between the first substrate and the second substrate; and
at least one ion layer, formed on a surface of the electrochromic layer, and prepared by mixing and dissolving at least one organic material and at least one inorganic material into a solvent.

42. The stereo image display device of claim 41, wherein when the stereo image display device comes with a plurality of first electrically conductive elements and ion layers, each of the first electrically conductive elements is in form of a containing slot for containing the corresponding electrochromic layer and ion layer.

43. The stereo image display device of claim 41, wherein when the stereo image display device comes with a plurality of first electrically conductive elements and ion layers, the stereo image display device further comprises a plurality of isolating units installed among the first electrically conductive elements, the electrochromic layers and the ion layers.

44. The stereo image display device of claim 43, wherein the isolating units are photoresists.

45. The stereo image display device of claim 41, wherein when the stereo image display device comes with a plurality of first electrically conductive elements, the first electrically conductive elements provide positive and negative voltages alternately, and the electrochromic layers are in form of a containing slot respectively for containing the corresponding first electrically conductive elements that carry negative electricity.

46. The stereo image display device of claim 41, wherein when the stereo image display device comes with a plurality of first electrically conductive elements, the first electrically conductive elements provide positive and negative voltages alternately, and the electrochromic layers are respectively formed on the first electrically conductive elements that carry negative electricity.

47. The stereo image display device of claim 41, further comprising at least one second electrically conductive element corresponding to the first electrically conductive element and disposed on a lower surface of the second substrate.

48. The stereo image display device of claim 47, wherein when the stereo image display device comes with a plurality of first electrically conductive elements, second electrically conductive elements and ion layers, each of the first electrically conductive elements and second electrically conductive elements is in form of a containing slot for containing the corresponding electrochromic layer and ion layer.

49. The stereo image display device of claim 47, wherein when the stereo image display device comes with a plurality of first electrically conductive elements, second electrically conductive elements and ion layers, the stereo image display device further comprises a plurality of isolating units installed among the first electrically conductive elements, the second electrically conductive elements, the electrochromic layers and the ion layers.

50. The stereo image display device of claim 49, wherein the isolating units are photoresists.

51. The stereo image display device of claim 47, wherein when the stereo image display device comes with a plurality of first electrically conductive elements, the first electrically conductive elements provide positive and negative voltages alternately, and the electrochromic layers are separately in form of a containing slot for containing the corresponding first electrically conductive elements that carry negative electricity.

52. The stereo image display device of claim 47, wherein when the stereo image display device comes with a plurality of first electrically conductive elements, the first electrically conductive elements provide positive and negative voltages alternately, and the electrochromic layers are respectively formed on the first electrically conductive elements that carry negative electricity.

53. The stereo image display device of claim 41, wherein the first substrate and the second substrate are made of a material selected from the collection of plastic, polymer plastic and glass, or a plastic polymer selected from the collection of resin, polyethylene terephthalate (PET), polycarbonate (PC), polyethylene (PE), polyvinyl chloride (PVC), polypropylene (PP), polystyrene (PS) and polymethylmethacrylate (PMMA).

54. The stereo image display device of claim 41, wherein the first electrically conductive element is an impurity-doped oxide selected from the collection of indium tin oxide (ITO), indium zinc oxide (IZO), al-doped ZnO (AZO) and antimony tin oxide (ATO).

55. The stereo image display device of claim 41, wherein the first electrically conductive element is made of an electrically conductive polymer selected from the collection of carbon nanotube and poly-3,4-ethylenedioxythiophene (PEDOT).

56. The stereo image display device of claim 41, wherein the electrochromic layer is made of an organic electrochromic material, an inorganic electrochromic material, a transition metal oxide, a transition metal compound, or a composite of the organic electrochromic material and the transition metal compound.

57. The stereo image display device of claim 56, wherein the organic electrochromic material is a redox compound selected from the collection of bipyridyls, viologen, anthraquinone, tetrathiafulvalene, pyrazolone and their derivatives.

58. The stereo image display device of claim 56, wherein the organic electrochromic material is an electrically conductive polymer selected from the collection of polyacetylene, polyaniline, polypyrrole, polythiophene, poly-3-alkylthiophene, polyfuran, polyphenylene, aromatic polyamide/polyimide, polyphenylenevinylene and their derivatives.

59. The stereo image display device of claim 56, wherein the organic electrochromic material is a polymeric metal complex and its derivative.

60. The stereo image display device of claim 56, wherein the organic electrochromic material is a coordination complex of a transition metal or a lanthanide element or their derivatives.

61. The stereo image display device of claim 56, wherein the organic electrochromic material is zinc phthalocyanine and its derivative.

62. The stereo image display device of claim 56, wherein the organic electrochromic material is ferrocene or iron(III) thiocyanate dissolved in a water solution, hexacyanoferrate dissolved in a tetracyanoquino solution or tetrasulfur cyanide dissolved in an acetonitrile solution.

63. The stereo image display device of claim 56, wherein the transition metal oxide is an anodic coloration transition metal oxide selected from the collection of chromium oxide (Cr₂O₃), nickel oxide (NiOₓ), iridium oxide (IrO₂), maganese oxide (MnO₂), nickel hydroxide Ni(OH)₂ and tantalum pentoxide (Ta₂O₅).

64. The stereo image display device of claim 56, wherein the transition metal oxide is a cathodic coloration transition metal oxide selected from the collection of tungsten oxide (WO₃), molybdenum oxide (MoO₃), niobium oxide (Nb₂O₃), titanium oxide (TiO₂), strontium titanium oxide (SrTiO₃) and tantalum pentoxide (Ta₂O₅).

65. The stereo image display device of claim 56, wherein the transition metal oxide is a cathodic/anodic coloration transition metal oxide selected from the collection of vanadium oxide (V₂O₂), rhodium oxide (Rh₂O₃) and cobalt oxide (CoOₓ).

66. The stereo image display device of claim 56, wherein the transition metal compound is Prussian blue (Fe₄[Fe(CN)₆]₃).

67. The stereo image display device of claim 56, wherein the inorganic electrochromic material is a Li, K, Mg, Cr, Cu or Ba doped C60 thin film.

68. The stereo image display device of claim 41, wherein the organic material of the ion layer is a redox indicator or a pH indicator (acid-base indicator).

69. The stereo image display device of claim 68, wherein the redox indicator is methylene blue (C₁₆H₁₈ClN₃S.3H₂O), dichlorophenolindophenol sodium (C₁₂H₆Cl₂NNaO₂), N-phenyl-o-anthranilic acid (C₁₃H₁₁NO₂), sodium diphenylamine sulfonate (C₁₂H₁₀NNaO₃S), N,N′-diphenylbenzidine (C₂₀H₂₀NN₂) or viologen.

70. The stereo image display device of claim 68, wherein the pH indicator is a variamine blue B diazonium salt (C₁₃H₁₂ClN₃O).

71. The stereo image display device of claim 41, wherein the inorganic material of the ion layer is an inorganic derivative.

72. The stereo image display device of claim 71, wherein the inorganic derivative is an oxide, a sulfide, a chloride or a hydroxide of a transition element.

73. The stereo image display device of claim 72, wherein the transition element is one selected from the collection of a scandium subgroup (IIIB), a titanium subgroup (IVB), a vanadium subgroup (VB), a chromium subgroup (VIB), a manganese subgroup (VIIB), an iron series (VIII), a copper subgroup (IB), a zinc subgroup (IIB) and a platinum series (VIII).

74. The stereo image display device of claim 71, wherein the inorganic derivative is one selected from the collection of a halogen group (VIIA), an oxygen group (VIA), a nitrogen group (VA), a carbon group (IVA), a boron group (IIIA), an alkali earth metal group (IIA) and an alkali metal group (IA).

75. The stereo image display device of claim 41, wherein the inorganic material of the ion layer is ferrous chloride (FeCl₂), ferric trichloride FeCl₃), titanium trichloride (TiCl₃) or titanium tetrachloride (TiCl₄), bismuth chloride (BiCl₃), copper chloride (CuCl₂) or lithium bromide (LiBr).

76. The stereo image display device of claim 41, wherein the ion layer further includes at least one inert conductive salt.

77. The stereo image display device of claim 76, wherein the inert conductive salt is a lithium salt, a sodium salt, or a tetraalkylammonium salt.

78. The stereo image display device of claim 41, wherein the solvent of the ion layer is dimethyl sulfoxide [(CH₃)₂SO], propylene carbonate (C₄H₆O₃), water (H₂O), γ-butyrolactone, acetonitrile, propionitrile, benzonitrile, glutaronitrile, methyl glutaronitrile, 3,3′-oxy-2-propionitrile, hydroxyl propionitrile, dimethyl-formamide, N-methylpyrrolidone, sulfone, 3-methyl sulfone or their mixtures.

79. The stereo image display device of claim 47, wherein the first electrically conductive element and the second electrically conductive element are made of an impurity-doped oxide selected from the collection of indium tin oxide (ITO), indium zinc oxide (IZO), al-doped ZnO (AZO) and antimony tin oxide (ATO).

80. The stereo image display device of claim 47, wherein the first electrically conductive element and the second electrically conductive element are made of an electrically conductive polymer selected from the collection of carbon nanotube and poly-3,4-ethylenedioxythiophene (PEDOT).
